(19) United States
(12) Patent Application Publication
(10) Pub. No.: US 2015/0045484 A1
(43) Pub. Date: Feb. 12, 2015

(54) AMINO GROUP-CONTAINING PHOSPHATE ESTER FLAME RETARDANT AND METHOD OF PREPARING THE SAME

(71) Applicant: LG HAUSYS, LTD., Seoul (KR)

(72) Inventors: In Suk Yang, Cheongju-si (KR); Jong Cheol Lee, Cheongju-si (KR)

(21) Appl. No.: 14/385,706

(22) PCT Filed: Mar. 21, 2013
(86) PCT No.: PCT/KR2013/002365

§ 371 Date: Sep. 16, 2014

(30) Foreign Application Priority Data
Mar. 21, 2012 (KR) 10-2012-0028556

(51) Int. Cl. C08K 5/521

(52) U.S. Cl. CPC C08K 5/521
USPC 524/140; 558/166; 558/87

(57) ABSTRACT

The present invention relates to an amino group-containing phosphate ester flame retardant which has both a phosphate group and an amine group to exhibit a good flame retarding effect while overcoming the problems with the conventional phosphor-based flame retardants not having a good flame retarding effect with respect to its added amount, and a method of preparing the same.

### TECHNICAL FIELD

The present invention relates to an amino group-containing phosphate ester flame retardant and a method of preparing the same and, more particularly to an amino group-containing phosphate ester flame retardant which has both a phosphate group and an amine group to exhibit a good flame retarding effect while overcoming the problems with the conventional phosphor-based flame retardants not having a good flame retarding effect with respect to its used amount, and a method of preparing the same.

### BACKGROUND ART

Conventionally, organic halogen compounds have been added as a flame retardant in order to provide flame retardant properties for a resin composition containing thermosetting resins, such as epoxy resins, unsaturated polyester resins, phenol resins, or melamine resins, and thermoplastic resins, such as ABS resins, AS resins, PET resins, PBT resins, or PMMA resins. Such a resin compositions containing organic halogen compounds has excellent flame retardant properties but problematically generates deadly poisonous dioxins adversely affecting the environments when heated during the molding process or incinerated after use. For that reason, there has been suggested the use of phosphor-based flame retardants as a substitute for the organic halogen compounds.

Generally, the phosphor-based flame retardants contain triphenyl phosphate (TPP) to induce char formation in combination with melamine cyanate used as a nitrogen compound to enhance char formation. In this case, however, triphenyl phosphate (TPP) and melamine cyanate differ in thermal decomposition temperature from each other, so the flame retardants hardly exert a good flame retarding effect with respect to its used amount.

### DISCLOSURE OF INVENTION

### Technical Problem

The inventors of the present invention have made an attempt to synthesize a compound having both a phosphate group and an amine group and thus increase the flame retarding effect, with a view of improving the aforementioned problem with the prior art that uses triphenyl phosphate (TPP) as a char-forming phosphor-based flame retardant in combination with melamine cyanate as a nitrogen compound to enhance char formation and thus hardly cannot have a good flame retarding effect with respect to its used amount, since triphenyl phosphate (TPP) and melamine cyanate differ in thermal decomposition temperature from each other. Applying a first flame retardant containing chlorines and then a second flame retardant free from chlorine to an acryl resin enables the preparation of an acryl-based flame retardant that has good flame regarding properties.

It is an object of the present invention to provide an amino group-containing phosphate ester flame retardant having good flame retardant properties and a method of preparing the same.

This and other objects of the present invention can be achieved by the present invention in the following description.

### Solution to Problem

To achieve the object of the present invention, the present invention provides an amino group-containing phosphate ester flame retardant that includes both an amino group and a phosphate group.

The present invention also provides a method of preparing an amino group-containing phosphate ester flame retardant that includes: (a) reacting trichlorophosphate with an alcohol to synthesize trialkyl phosphate; and (b) reacting the trialkyl phosphate with an amino alcohol or an amino halogen salt to synthesize an amino phosphate ester or a halogenated amino phosphate ester.

In addition, the present invention further provides a flame retardant resin composition including 5 to 50 wt % of the amino group-containing phosphate ester flame retardant; and 50 to 95 wt % of a resin.

### Advantageous Effects of Invention

The present invention, which includes both a phosphate group and an amine group, can be applied to an acryl-based resin to improve the flame retarding effect.

### Mode for the Invention

Hereinafter, a detailed description will be given as to the present invention.

The present invention provides an amino group-containing phosphate ester flame retardant that includes both an amino group and a phosphate group.

Among the amino group-containing phosphate ester flame retardants, non-halogen flame retardants may be selected from the group consisting of, it not specifically limited to, tris-(2-diethylamino-ethyl)phosphate, tris-(2-dimethylamino-ethyl)phosphate, tridimethylaminomethyl phosphate, tridiethy-laminomethyl phosphate, bis-(2-dimethylamino-ethyl)methyl-phosphate, bis-(2-diethylamino-ethyl)methyl-phosphonate, di-diethylaminomethylmethyl-phosphate, triethylamino phosphate, diethylamino methylamino phosphate, dimethylamino ethylamino phosphate, diethylaminomethyl dimethyl phosphate, 2-diethylamino-ethyldimethyl phosphate, and 2-dimethylamino-ethyl-dimethyl phosphate.

More specifically, tris-(2-diethylamino-ethyl)phosphate or tridirnethylaminomethyl phosphate can be represented by the following formula 1 or 2.

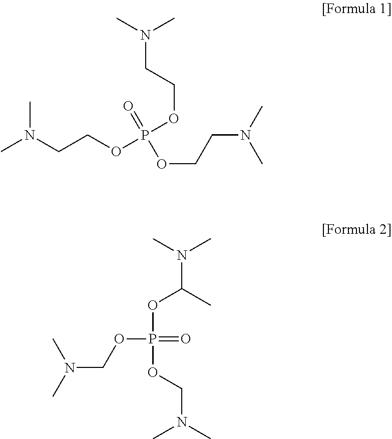

The amino group containing phosphate ester may be substituted With a halogen, such as fluorine (F), chlorine (Cl) bromine (Br), or iodine (I). More specifically, the chlorine-based, amino group-containing phosphate ester may be selected from the group consisting of if not specifically limited to, tris-[2-(bis-chloromethyl-amino)-ethyl] phosphate, tris-[2-(chloromethyl-ethyl-amino)-ethyll phosphate, tris-(bis-chloromethyl-amino)-methyl] phosphate, tris-[(chloromethyl-ethyl-amino)-methyl] phosphate, tri(1-chloropropyl) phosphate, tri(3-chloropropyl) phosphate, tri(2-chloroethyl) phosphate, tris-(2,2-dichloro-ethyl) phosphate, tris-(1,2-dichloro-ethyl) phosphate, tris-(3,3-dichloro-propyl) phosphate, tris-(2,3-dichloro-propyl) phosphate, tris-(1,3-dichloro-propyl) phosphate, 3-chloro-propyl-dipropyl phosphate, 2-chloro-propyl-dipmpyl phosphate, di(3-chloro-propyl-propyl) phosphate, di(2-chloro-propyl-propyl) phosphate, 2-chloro-ethyl-diethyl phosphate, and di(2-chloro-ethyl-ethyl) phosphate.

The present invention also provides a method of preparing an amino group-containing phosphate ester flame retardant that includes: (a) reacting trichlorophosphate ester with an alcohol to synthesize trialkyl phosphate ester; and (b) reacting the trialkyl phosphate ester with an amino alcohol or an amino halogen salt to synthesize an amino phosphate ester or a halogenated amino phosphate ester as a final product, where the phosphate ester is selected from the group consisting of phosphate, phosphonate, and phosphinate.

The prepartion method for tris-(2-diethylamino-ethyl) phosphate and tridimethylaminomethyl phosphate as represented by the formula 1 or 2 among the amino group-containing phosphate ester flame retardants according to the present invention can be represented by the reaction scheme as follows.

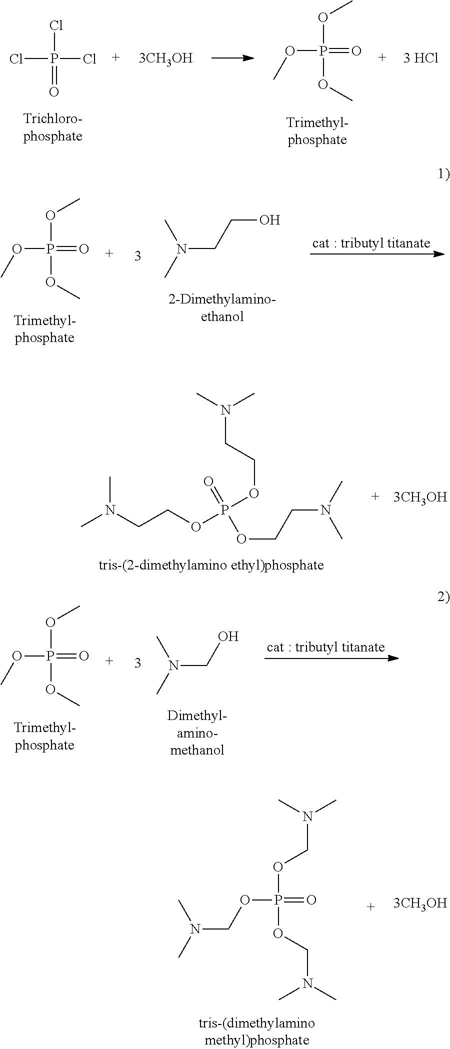

In the preparation method of the present invention, preferably, the step (a) is carried out in the temperature range from 0° C. to 60° C. for 5 to 15 hours, and the, Step (b) is carried out in the temperature range from 50° C. to 100° C. for 5 to 15 hours:

The alcohol used,in the step (a) may be selected from the group consisting of methanol, ethanol, propanol, and butanol. But, the alcohol may include (1) ethanol type or (2) methanol type in order to control the thermal characteristics and migration characteristics of the product.

The amino alcohol used in the step (b) may be selected from the group consisting of 2-dimethyl amino ethanol, dimethyl amino ethanol, 2-dimethyl amino methanol, and 2-dimethyt amino propanol, and may be preferably 2-dimethyl amino ethanol.

Further, the amino halogen salt used in the step (b) may be selected from the group consisting of 2-bis-chioroethyl amine, 2-chloromethylethyl amine, bis-chloroethyl amine, and chloromethylethyl amine, and may be preferably bis-chloroethyl amine.

The present invention also provides a flame retardant resin composition containing 5 to 50 wt % of the amino group-containing phosphate ester flame retardant; and 50 to 95 wt % of a resin.

The above-defined content of the flame retardant can provide a flame retarding effect which meets the UL-94V standards.

The flame retardant of the present invention can be applied to other resins, such as acryl-based resins, urethane or polycarbonate resins, etc., and mainly applicable to acryl-based resins.

Hereinafter, preferable examples of the present invention will be provided to facilitate the better understanding of the present invention. It would be understood by those skilled in the art that various changes and modifications may be made without changing the scope and the technical conception of the present invention and construed to be included in the accompanying claims of the present invention.

### EXAMPLES

### Example 1: Preparation of Tris-(Dimethylamino Methyl) Phosphate

689.7 g of trichlorophosphate (POCl₃) is added to 1,995 g of toluene at the room temperature, and 640.3 g of ethanol (C₂H₅OH) is then added dropwise for 3 hours to yield 492 g of hydrogen chloride (HCl). The hydrogen chloride thus obtained is aged at the room temperature for 5 hours and subjected to a 5-hour topping with toluene at 140° C., a 2-hour vacuum topping (1 ton) at 110° C., and then filtration to yield 819.3 g of the primary reaction product, triethyl phosphate (C₆H₁₅PO₄).

794.7 g of trimethyl phosphate (C₃H₉PO₄) as produced above is added to 2,168 g of toluene heated up to 110° C. and 10 g of tyzor TBT. The resultant mixture is subjected to a solvent reflux topping while mixed with dimethylamino methanol (C₃H₉NO) which is added dropwise at 130° C. for 3 hours, to obtain 603.0 g of ethanol (C₂H₅OH). The ethanol is aged at 130° C. for 5 hours and subjected to a 5-hour topping with toluene at 150° C., a 2-hour vacuum topping (1 ton) at 150° C., and then filtration to yield 1,000 g of the final product, tris-(dimethylamino methyl) phosphate (C₉H₂₄N₃PO₄)

The quantities (weight and the number of moles) of the reactants and the products, and the yield as given in Example 1 are presented in Table 1.

TABLE 1

| | | | | | Number | | |
|---|---|---|---|---|---|---|---|
| | | | Weight | Molecular | of moles | Yield | |
| | | Compound | (g) | weight | (mol) | (%) | Note |
| First reaction | Reactants | POCl₃ | 689.7 | 153.3320 | 4.4979 | — | — |
| (ethylation) | | C₂H₅OH | 640.3 | 46.0684 | 13.4937 | — | 3% excess |
| | | Toluene | 1994.9 | — | — | — | *(a) |
| | Products | C₆H₁₅PO₄ | 819.3 | 182.1550 | 4.4979 | 97.00 | |
| | | HCl | 492.0 | 36.4609 | 13.4937 | — | — |
| Second reaction | Reactants | C₆H₁₅PO₄ | 794.7 | 182.1550 | 4.3630 | — | — |
| (methyl- | | C₃H₉NO | 1012.6 | 75.1097 | 13.0889 | — | 3% excess |
| amination) | | Toluene | 2168.8 | — | — | — | *(b) |
| | | Tyzor TBT | 10.0 | — | — | — | *(c) |
| | Products | C₉H₂₄N₃PO₄ | 1000.0 | 241.2650 | 4.3630 | 95.00 | — |
| | | C₂H₅OH | 603.0 | 46.0684 | 13.0889 | — | — |

Note)
*(a): 1.5 time more than reactants.
*(b): Solvent, 1.2 time more than reactants.
*(c): Tributyl titanate (Dupont), 1 phr of reactants.

### Experiment Example

The sample obtained in Example 1 is measured in regard to properties in the manner as described below. The measurement results are presented in Table 2.
Candle Test: The flame of a burning candle is placed next to the target portion of a plastic product of which the external plastic has the total weight of 300 g or greater (candle accessible area between 10 mm of base and up to 150 mm of base) for 3 minutes. The product is considered as up to the standards when the duration of the flame on the product is 3 minutes or less after removal of the candle.
Flame Retardant Performance (UL94-V): UL94-V is injection-molded into a specimen of a defined dimension (125±5 mm×13.0±5 mm×13.0 mm or less), which specimen is kept under conditions, such as (1) at 23±2° C. and 50±5% R.H. for 4 hours; or (2) at 70±1° C. for 168 hours, followed by 4-hour cooling down to the room temperature. The specimen is placed in a vertical position and lit with a burner to determine whether it can self-distinguish within a defined time. Based on the time taken for the specimen to self-distinguish, the UL94-V specimen is classified as V2, V1, or V0 according to the criteria given as follows.

(1) V0: The specimen is placed and lit with a burner for 10 seconds. After removal of the burner, the duration of the flame on the specimen does not exceed 10 seconds. When the same test is conducted 10 times with one set of five samples, the total duration of combustion does not exceed 50 seconds. During combustion, there occurs no melt dripping and thus no ignition of the cotton ball placed 30 cm below the specimen.

(2) V1: The test procedures are the same as described in the V0 ranking, After removal of the burner, the duration of the flame on the specimen does not exceed 30 seconds. The total duration of 10-time combustions is 250 seconds or less. During combustion, and there is no ignition on the cotton ball caused by a melt dripping.

(3) V2: After removal of the burner, the duration of the flame on the specimen is 30seconds or less: As in the case of V1, the total duration of 10-time combustions is 250 seconds or less. Unlike, the case of V1, melt dripping m occur to ignite the cotton ball.

TABLE 2

| Specimen | 1 | 2 | 3 | 4 | 5 |
|---|---|---|---|---|---|
| Candle test | Passed | Passed | Passed | Passed | Passed |
| UL94-V | V0 | V0 | V0 | V0 | V0 |

It is demonstrated that the amino group-containing phosphate ester flame retardant according to an embodiment of the present invention has both a phosphate group and an amino group and thus exhibits a good flame retarding effect with respect to its used amount.

1. An amino group-containing phosphate ester flame retardant comprising both an amino group and a phosphate group.

2. The amino group-containing phosphate ester flame retardant as claimed in claim 1, wherein the amino group-containing phosphate ester is selected from the group consisting of tris-(2-diethylamino-ethyl)phosphate, tris-(2-dimethylamino-ethyl)phosphate, tridimethylaminomethyl phosphate, tridiethylaminomethyl phosphate, bis-(2-dimethylamino-ethyl)methyl-phosphate, bis-(2-diethylamino-ethyl)methyl-phosphonate, di-diethylaminomethylmethyl-phosphate, triethylamino phosphate, di-ethylamino methylamino phosphate, dimethylamino ethylamino phosphate, diethylaminomethyl dimethyl phosphate, 2-diethylamino-ethyldimethyl phosphate, and 2-dimethylamino-ethyl-dimethyl phosphate.

3. The amino group-containing phosphate ester flame retardant as claimed in claim 1, wherein the amino group-containing phosphate ester is substituted with a halogen.

4. The amino group-containing phosphate ester flame retardant as claimed in claim 3, wherein the halogen is fluorine, chlorine, bromine, or iodine.

5. The amino group-containing phosphate ester flame retardant as claimed in claim 3, wherein amino group-containing phosphate ester flame retardant is selected from the group consisting of tris-[2-(bis-chloromethyl-amino)-ethyl] phosphate, tris-[2-(chloromethyl-ethyl-amino)-ethyl] phosphate, tris-[(bis-chloromethyl-amino)-methyl] phosphate, tris-[(chloromethyl-ethyl-amino)-methyl] phosphate, tri(1-chloropropyl) phosphate, tri(3-chloropropyl) phosphate, tri(2-chloroethyl) phosphate, tris-(2,2-dichloro-ethyl) phosphate, tris-(1,2-dichloro-ethyl) phosphate, tris-(3,3-dichloro-propyl) phosphate, tris-(2,3-dichloro-propyl) phosphate, tris-(1,3-dichloro-propyl) phosphate, 3-chloro-propyl-dipropyl phosphate, 2-chloro-propyl-dipropyl phosphate, di(3-chloro-propyl-propyl) phosphate, di(2-chloro-propyl-propyl) phosphate, 2-chloro-ethyl-diethyl phosphate, and di(2-chloro-ethyl-ethyl) phosphate.

6. A method of preparing an amino group-containing phosphate ester flame retardant, comprising:
(a) reacting trichlorophosphate with an alcohol to synthesize trialkyl phosphate; and
(b) reacting the trialkyl phosphate with an amino alcohol or an amino halogen salt to synthesize an amino phosphate ester or a halogenated amino phosphate ester, wherein the phosphate ester is selected from the group consisting of phosphate, phosphonate, and phosphinate.

7. The method as claimed in claim 6, wherein the step (a) is carried out in the temperature range from 0° C. to 60° C. for 5 to 15 hours.

8. The method as claimed in claim 6, wherein the alcohol in the step (a) is selected from the group consisting of methanol, ethanol, propanol, and butanol.

9. The method as claimed in claim 6, wherein the amino alcohol in the step (b) is selected from the group consisting of 2-dimethyl amino ethanol, dimethyl amino ethanol, 2-dimethyl amino methanol, and 2-dimethyl amino propanol.

10. The method as claimed in claim 6, wherein the amino halogen salt in the step (b) is selected from the group consisting of 2-bis-chloroethyl amine, 2-chloromethylethyl amine, bis-chloroethyl amine, and chloromethylethyl amine.

11. The method as claimed in claim 6, wherein the step (b) is carried out in the temperature range from 50° C. to 100° C. for 5 to 15 hours.

12. A flame retardant resin composition comprising:
5 to 50 wt5 of the amino group-containing phosphate ester flame retardant as claimed in claims 1; and
50 to 95 wt % of a resin.

13. The flame retardant resin composition as claimed in claim 12, wherein the resin is selected from the group consisting of acryl-based resin, urethane-based resin, and polycarbonate.
